(19) United States
(12) Patent Application Publication
(10) Pub. No.: US 2014/0341329 A1
(43) Pub. Date: Nov. 20, 2014

(54) DEVICE FOR MONITORING AND COLLECTING INFORMATION FROM AN AREA WITH POTENTIAL RISK OF IRRADIATION

(71) Applicants: Thierry GODER, La Valette du Var (FR); Victorien FRADEL, Hyeres (FR)

(72) Inventors: Thierry GODER, La Valette du Var (FR); Victorien FRADEL, Hyeres (FR)

(73) Assignee: ECA ROBOTICS, La Garde (FR)

(21) Appl. No.: 14/277,469

(22) Filed: May 14, 2014

(30) Foreign Application Priority Data
May 15, 2013 (FR) 1354340

(51) Int. Cl. G21C 17/013; G21F 7/06; G05D 1/00; B25J 5/00

(52) U.S. Cl. CPC G21C 17/013; B25J 5/007; G21F 7/063; G05D 1/0038
USPC 376/249

(57) ABSTRACT

A device for monitoring and collecting information (10) from an area with potential risk of irradiation, including at least one storage box (12) intended to be positioned permanently in a nuclear infrastructure (2) and including a unit for communication with a control station (14) intended to be positioned outside (8) the nuclear infrastructure (2), characterized in that the storage box (12) is intrinsically protected from any external stresses, and includes a televisual inspection unit and a unit for measuring environmental parameters that can be deployed from inside the nuclear infrastructure (2).

### FIELD OF THE INVENTION

The present invention relates to the field of monitoring devices, and in particular, devices for monitoring an area that is potentially irradiated or at risk of so being, such as nuclear power plants, in particular the reactor or fuel storage buildings, or waste storage sites.

### BACKGROUND OF THE INVENTION

In nuclear accidents occurring in such places, there can be rupturing of the containment therein, radiations and explosions which destroy most of the monitoring devices. The equipment inside the nuclear infrastructure can be rendered inoperative and access to the premises can be rendered difficult, even impossible, through the presence of rubble or a high radiation and/or temperature level. Intervention in a strongly irradiated and contaminated area requires the use of remote-controlled means such as robots. However, their deployment from outside the irradiated or contaminated area is often difficult, even impossible, for example because of the presence of debris on the ground and the low resistance of the equipment to radiation.

There are mobile robots that allow access to the areas present in hostile environments, from a transport container.

Reference in this regard can be made to the document U.S. Pat. No. 4,736,826 which describes a mobile robot linked by a cable to a control station. The cable is fastened inside a storage enclosure that has a recess making it possible to store the mobile robot and avoid any movement of the robot when the latter is stored inside the enclosure. The storage enclosure serves as a container used for the storage of the mobile robot in its transport in order to eliminate any risk of outside contamination.

However, it is often difficult to bring the storage enclosure into the irradiated area following an accident.

The aim of the present invention is to overcome the drawbacks of the prior art.

### SUMMARY OF THE INVENTION

The present invention aims to remedy these drawbacks by permanently having available, inside a nuclear infrastructure, and in particular areas with potential risk of irradiation, a device for monitoring and collecting information that is suitable for withstanding the environmental constraints and suitable for deployment only in the case of need, notably after a nuclear accident.

The subject of the invention is a device for monitoring and collecting information from an area with potential risk of irradiation, comprising at least one storage box intended to be positioned permanently in a nuclear infrastructure and comprising means for communication with a control station intended to be positioned outside the nuclear infrastructure.

The storage box is intrinsically protected from any external stresses and comprises televisual inspection means and means for measuring environmental parameters, such as, for example, the outside temperature, the radiation level, the hydrometry, the gas analysis, which can be deployed from inside the nuclear infrastructure.

The monitoring device makes it possible to monitor and collect the information from an area that is irradiated or that has a potential risk of so being, such as, for example, in the enclosure of a nuclear power plant, in the reactor building or the fuel building, while being effectively protected against the external stresses such as, for example, an earthquake, a fall, a high radiation level, a high temperature, for example of 400° C., fire, immersion or blasts. In a nuclear accident, the information collected by the monitoring device is then immediately transmitted to the control station, which makes it possible to quickly obtain the information needed to supervise any intervention.

In one embodiment, the device for monitoring and collecting information comprises at least one inspection and/or intervention device intended to be stored in the storage box and comprising means for communication with the storage box.

The inspection and/or intervention device comprises, for example, televisual inspection means and/or means for measuring environmental parameters, such as, for example, the outside temperature, the radiation level, the hydrometry, gas analysis.

The communication means of the inspection device can be wired or remote links, for example wireless.

The monitoring and/or intervention device communicates with the remote control station via the storage box.

Advantageously, the storage box comprises a retractable shielded door making it possible to deploy the inspection and/or intervention device.

According to another embodiment, the device for monitoring and collecting information comprises at least one relay communication module intrinsically protected from any external stresses and intended to be positioned permanently in a nuclear infrastructure and comprising means for communication with the storage box, the remote control station and the inspection and/or intervention device.

The relay communication module makes it possible both to add to the information collected by the storage box and the inspection and/or intervention device, and to act as relay for the inspection and/or intervention device. In this case, the inspection and/or intervention device communicates with the remote control station via the relay communication module.

The relay communication module comprises, for example, means for measuring environmental parameters and/or televisual inspection means.

Advantageously, the relay communication module comprises means for measuring the radiation level, the hydrometry, gas analysis means and a camera, for example an infrared camera.

The relay communication module may comprise an ingress-protected and shielded jacket/covering in order to be effectively protected against the external stresses such as, for example, an earthquake, a fall, a high radiation level, a high temperature, for example of 400° C., fire, immersion or even blast.

According to one embodiment, the inspection device is a mobile robot.

The mobile robot may comprise means for measuring the radiation level, the hydrometry, gas analysis means and a camera, for example of infrared type.

The robot may also comprise intervention means, such as, for example, at least one manipulator arm making it possible to clear an area cluttered with debris, notably after a nuclear explosion.

Advantageously, the storage box comprises an ingress-protected and shielded jacket made of a material ensuring the radiation protection and the containment of its internal equipment. The jacket is, for example, made of steel, lead or concrete, or a combination of these materials.

The storage box may comprise at least one inspection camera. Advantageously, the storage box comprises three inspection cameras.

The communication means of the storage box are, for example, wired or wireless remote links.

### BRIEF DESCRIPTION OF THE DRAWINGS

Other aims, features and advantages of the invention will become apparent on reading the following description, given as a nonlimiting example, and with reference to the attached drawings in which:

FIG. 1 is an overview of a device for monitoring and collecting information according to the invention in a nuclear infrastructure;

FIG. 2 is a perspective view of the storage box according to FIG. 1;

FIG. 3 is a cross-sectional view of a storage box comprising an inspection and/or intervention device;

FIG. 4 is a cross-sectional view on IV-IV of the storage box according to FIG. 3;

FIG. 5 schematically illustrates the entire monitoring device with all the systems; and

FIG. 6 represents a side view of a relay communication module according to FIG. 5.

### DETAILED DESCRIPTION OF THE INVENTION

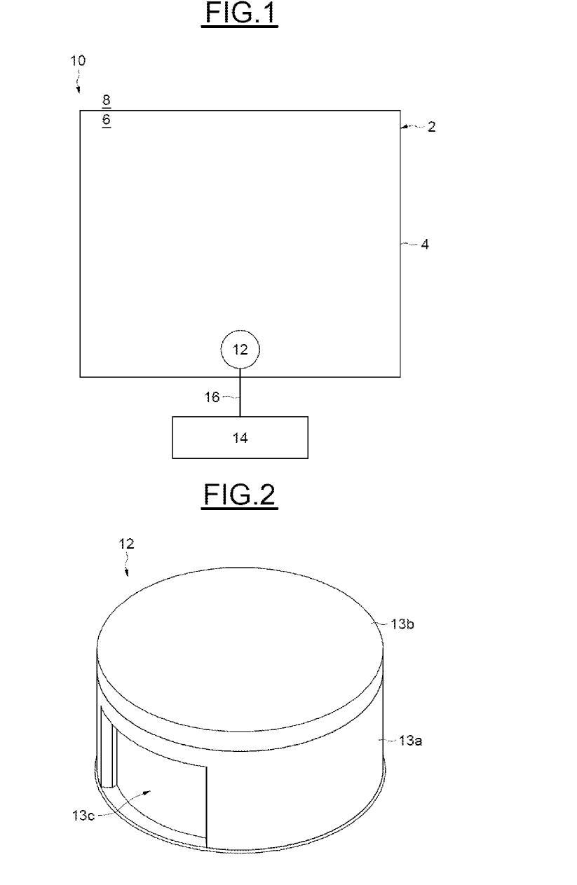

As is illustrated in FIG. 1, a device for monitoring and collecting information, referenced 10 overall, is intended to monitor and collect the information from an area that is irradiated or with a potential risk of so being, in a nuclear infrastructure 2, such as, for example, the enclosure of a nuclear power plant, in the reactor building or the fuel building. As represented, an enclosure wall 4 delimits the interior 6 and exterior 8 of the nuclear infrastructure 2.

The device for monitoring and collecting information 10 comprises a storage box/caisson 12 intended to be located in a permanent way inside the nuclear infrastructure 2 and a control station 14 intended to be positioned outside 8 the nuclear infrastructure 2 and linked to the storage box 12 by an electrical network 16.

The remote control station 14 enables people located outside 8 the area at risk to recover the data supplied by the storage box 12. Thus, in the event of an incident in the nuclear infrastructure 2, the intervention teams can muster in the remote control station 14 of the failing installation. This control station 14 makes it possible to supervise the operations after the accident on the basis of the data received by the storage box 12.

As illustrated in detail in FIGS. 2 to 4, the storage box 12 is intrinsically protected from any external stresses and, to this end, comprises an ingress-protected and shielded jacket 13a that is made, for example, of steel, lead, concrete or of a combination of materials ensuring radiation protection and containment of the equipment present inside the jacket. The ingress-protected and shielded jacket 13a provides effective protection against the external stresses such as, for example, an earthquake, a fall, a high level of radiation, a high temperature, for example of 400° C., fire, immersion or even blast. As illustrated, the storage box 12 comprises a cover 13b. It will be noted that the storage box 12 could be made of a single piece.

According to the embodiment illustrated, the storage box 12 is cylindrical. It will be noted that it would be possible to provide any other shape for the storage box 12.

The storage box 12 comprises, as a nonlimiting example, means for measuring environmental parameters, such as temperature, radiation level, hydrometry, gas analysis. As illustrated, the storage box 12 comprises a radiation level measurement sensor 16.

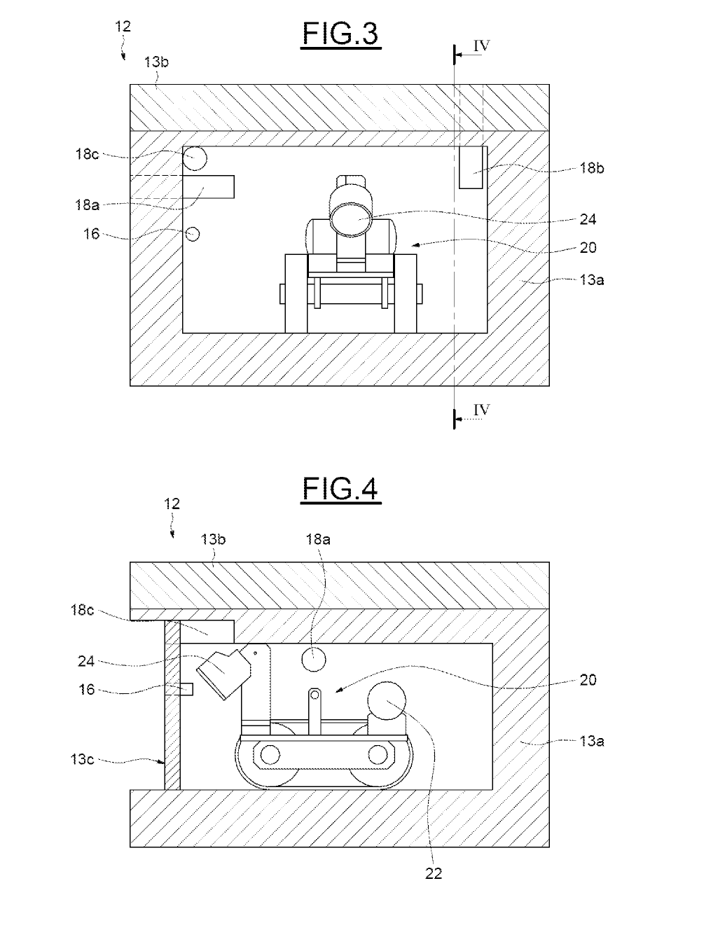

In order to view the status of the at-risk area after, for example, a nuclear accident, the storage box 12 comprises televisual inspection means 18 such as, for example, a camera. As a nonlimiting example, the storage box 12 is provided with three cameras 18a, 18b, 18c illustrated in FIG. 3. The cameras used have a high resistance to high radiation levels.

The storage box 12 also comprises means for communication (not represented) with the remote control station 14. Thus, the storage box 12 can collect a plurality of information concerning the outside environment inside 6 the nuclear infrastructure 2 and transmit such information outside 8 the at-risk area 2. In other words, the communication means of the storage box 12 transmit the information collected by the televisual inspection means 18 and the means 16 for measuring environmental parameters to the control station 14. The communication means may comprise an umbilical link cable or a communication antenna.

As illustrated in FIGS. 3 and 4, the device for monitoring and collecting information 10 comprises an inspection and/or intervention device 20 intended to be stored in the storage box 12 in order to increase the information collection range in the potentially irradiated area. The inspection and/or intervention device 20 comprises means 22 for measuring environmental parameters, such as temperature, radiation level, hydrometry, gas analysis. The inspection and/or intervention device 20 comprises, for example, a temperature sensor and a radiation level measurement sensor.

In order to view the status of the at-risk area after, for example, a nuclear accident, the inspection and/or intervention device 20 comprises televisual inspection means 24 such as, for example, a camera. The inspection and/or intervention device 20 may also comprise a dedicated lighting system (not represented) and an electrical energy accumulator means (not represented), such as, for example, an electric battery. To this end, the storage box 12 could comprise a means (not represented) for recharging the battery of the inspection and/or intervention device 20.

The inspection and/or intervention device 20 also comprises means (not represented) for communication with the storage box 12. The communication means of the inspection and/or intervention device 20 transmit the information collected by the means 22 for measuring environmental parameters and/or the televisual inspection means 24 to the control station 14 directly or via the storage box 12. The communication means may comprise a wired link cable or a radiocommunication antenna with, for example, a range of approximately 150 m. To this end, the storage box 12 could comprise a winder (not represented) making it possible to wind in the wired link of the inspection and/or intervention device 20.

The control of the inspection and/or intervention device 20 is thus managed remotely from the remote control station 14 via the storage box 12. In other words, the control of the inspection and/or intervention device 20 is managed remotely via the communication means of the storage box and of the inspection and/or intervention device 20.

As illustrated in FIGS. 2 and 4, the storage box 12 comprises a retractable shielded door 13c making it possible to deploy the inspection and/or intervention device 20. The radiation level measurement sensor 16 of the storage box 12 is mounted, for example, inside the shielded door 13c in order to increase its life.

As illustrated, the inspection and/or intervention device 20 is a mobile robot. The mobile robot 20 may be either an inspection robot, making it possible to collect information, or an intervention robot, or even an inspection and intervention robot. The mobile intervention robot makes it possible, for example, to clear an area, notably after a nuclear explosion and comprises, as a nonlimiting example, at least one manipulator arm (not represented). Thus, the intervention robots make it possible to widen the area to be monitored. As a variant, it would be possible to provide any other inspection and/or intervention device, such as, for example, an aerial or submarine drone, a telescopic arm, etc.

As a variant, it would be possible to provide for the monitoring device 10 not to have any inspection and/or intervention device 20 in the storage box 12.

The control station 14 may comprise, for example, a power cabinet in order to power the storage box 12, at least one supervision screen and means for controlling in particular the shielded door of the storage box, but also the mobile robots 20.

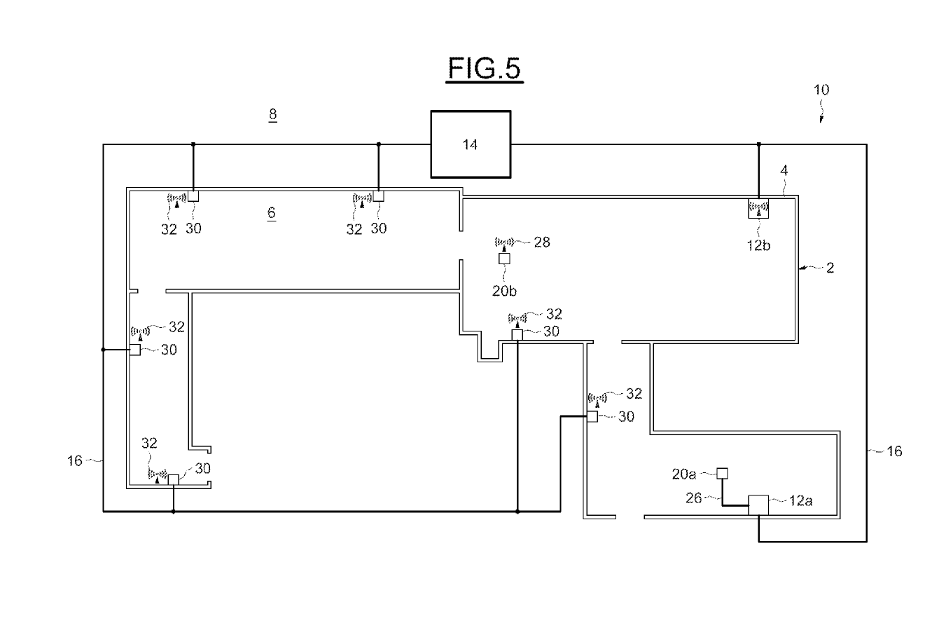

The embodiment illustrated in FIG. 5, wherein the same elements have the same references, differs from the embodiment illustrated in FIG. 1 by the number of storage boxes 12 and by the presence of relay communication modules 30.

As illustrated in FIG. 5, the monitoring device 10 comprises a first storage box 12a and a second storage box 12b positioned permanently in the nuclear infrastructure 2 and linked to the remote control station 14 by an electrical network 16. The storage boxes 12a, 12b are identical to the storage box 12 illustrated in FIGS. 1 to 4 and will not be described further. As a variant, provision could be made for the monitoring device 10 to comprise more than two storage boxes 12.

Each of the storage boxes 12a, 12b encloses an inspection and/or intervention device 20a, 20b. The inspection and/or intervention devices 20a, 20b are identical to the inspection and/or intervention device 20 illustrated in FIGS. 3 and 4 and will not be described further.

The inspection and/or intervention device 20a comprises a wired means 26 for communication with the associated storage box 12a. The inspection and/or intervention device 20b comprises a remote means 28 for communication, for example wireless, with the associated storage box 12b.

The monitoring device 10 comprises a plurality of relay communication modules 30 distributed and positioned permanently inside 6 the nuclear infrastructure 2 and linked to the remote control station 14 by the electrical network 16. To this end, each relay communication module 30 comprises means 32 for communication by radio antenna 34 with, respectively, the control station 14, the inspection and/or intervention device 20b and the storage boxes 12a, 12b. Thus, the communication modules 30 act as a relay making it possible to transmit the information collected by the inspection device 20b and/or the storage box 12a, 12b to the remote control station 14.

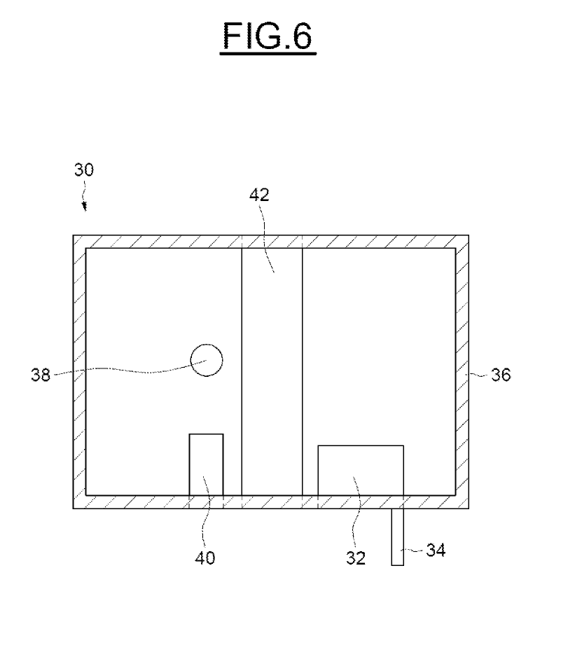

Each relay communication module 30, illustrated in detail in FIG. 6, is intrinsically protected from any external stresses and, to this end, comprises an ingress-protected and shielded jacket 36 made, for example, of steel, lead, concrete or of a combination of materials ensuring the radiation protection and containment of the equipment present inside the jacket 36. Each communication module 30 also comprises means for measuring environmental parameters, such as, for example, a temperature sensor 38, a radiation level measurement sensor 40. Each communication module 30 may comprise, as a nonlimiting example, means for measuring (not represented) the hydrometry, gas analysis, and televisual inspection means 42 such as, for example, a camera.

By virtue of the relay communication modules 30, the potentially irradiated area monitored by the monitoring device 10 is widened, which makes it possible for the intervention teams to obtain all the information needed to control the inspection and/or intervention devices 20 and supervise the operations after the accident that has occurred.

By virtue of the permanent presence of a monitoring device inside areas with potential risk of irradiation, the collection of information, necessary in order to supervise any intervention, is immediate. Furthermore, the monitoring device is suitable for withstanding the environmental stresses and for deployment notably after a nuclear accident.

1. Device for monitoring and collecting information (10) from an area with potential risk of irradiation in a nuclear infrastructure (2) comprising an enclosure wall (4) delimiting an interior (6) and an exterior (8), comprising at least one storage box (12, 12a, 12b) positioned permanently inside (6) the nuclear infrastructure (2) and comprising a control station (14) positioned on the outside (8) of the nuclear infrastructure (2), said storage box (12, 12a, 12b) comprising means for communication with the control station (14), characterized in that the storage box (12, 12a, 12b) is intrinsically protected from any external stresses, and comprises televisual inspection means (18) and means (16) for measuring environmental parameters.

2. Device according to claim 1, comprising at least one inspection and/or intervention device (20, 20a, 20b) stored in the storage box (12, 12a, 12b), said inspection and/or intervention device (20, 20a, 20b) comprising means for communication (26, 28) with the storage box (12a, 12b).

3. Device according to claim 2, wherein the inspection and/or intervention device (20, 20a, 20b) comprises televisual inspection means (24) and/or means (22) for measuring environmental parameters.

4. Device according to claim 2, wherein the communication means (26, 28) of the inspection and/or intervention device (20a, 20b) with the storage box (12a, 12b) are wired (26) or remote (28) links.

5. Device according to claim 2, wherein the storage box (12, 12a, 12b) comprises a retractable shielded door (13c) making it possible to deploy the inspection and/or intervention device (20, 20a, 20b).

6. Device according to claim 2, comprising at least one relay communication module (30) intrinsically protected from any external stresses and positioned permanently in the nuclear infrastructure (2) and comprising means for communication (32, 34) with the storage box (12a, 12b), the remote control station (14) and the inspection and/or intervention device (20b).

7. Device according to claim 6, wherein the communication means (32, 34) of the relay communication module (30) transmit the information collected by the inspection device (20b) and/or the storage box (12a, 12b) to the remote control station (14).

8. Device according to claim 6, wherein the relay communication module (30) comprises means (38, 40) for measuring environmental parameters and/or televisual inspection means (42).

9. Device according to claim 8, wherein the relay communication module (30) comprises means for measuring the radiation level (40), the hydrometry, gas analysis means and a camera (42).

10. Device according to claim 6, wherein the relay communication module (30) comprises an ingress-protected and shielded jacket (36).

11. Device according to claim 2, wherein the inspection and/or intervention device is a mobile robot (20, 20a, 20b).

12. Device according to claim 11, wherein the mobile robot (20, 20a, 20b) comprises means (22) for measuring the radiation level, the hydrometry, gas analysis means and a camera (24).

13. Device according to claim 11, wherein the mobile robot (20, 20a, 20b) comprises intervention means.

14. Device according to claim 1, wherein the storage box (12, 12a, 12b) comprises an ingress-protected and shielded jacket (13a) made of a material ensuring the radiation protection and the containment of its internal equipment.

15. Device according to claim 14, wherein the jacket (13a) is made of steel, lead or concrete.

16. Device according to claim 1, wherein the storage box (12, 12a, 12b) comprises at least one inspection camera (18).

17. Device according to claim 1, wherein the communication means of the storage box (12, 12a, 12b) with the control station (14) are wired or remote links.

18. Device according to claim 3, wherein the communication means (26, 28) of the inspection and/or intervention device (20a, 20b) with the storage box (12a, 12b) are wired (26) or remote (28) links.

19. Device according to claim 3, wherein the storage box (12, 12a, 12b) comprises a retractable shielded door (13c) making it possible to deploy the inspection and/or intervention device (20, 20a, 20b).

20. Device according to claim 4, wherein the storage box (12, 12a, 12b) comprises a retractable shielded door (13c) making it possible to deploy the inspection and/or intervention device (20, 20a, 20b).
